(19) United States
(12) Patent Application Publication
(10) Pub. No.: US 2008/0168667 A1
(43) Pub. Date: Jul. 17, 2008

(54) Portable cutting device with guiding guard

(76) Inventor: David Spinato, Montreal (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/480,565

(22) Filed: Jul. 5, 2006

Related U.S. Application Data
(60) Provisional application No. 60/732,454, filed on Nov. 2, 2005.

(51) Int. Cl. B27B 5/00; B27B 5/29

(52) U.S. Cl. 30/391; 30/276

(57) ABSTRACT

The invention concerns a portable cutting device for cutting different sized objects. It includes a frame, a circular blade and a guiding guard mounted to the frame and around the blade. The guiding guard includes first and second projections extending beyond the periphery of the blade. Each projection has an edge being spaced-apart from and facing the other edge, and defining there-between a cutting area having a peripheral entrance. This enables an insertable object to be cut as it is guided into the blade along the edge facing the rotation direction, and a partially insertable object to be partially cut as it abuts against borders of the peripheral entrance. It also includes a protector removably mounted around the peripheral entrance to removably cover it. The invention also concerns a guard with adjustment elements movably mounted thereto to adjust the dimensions of the cutting area.

### FIELD OF THE INVENTION

The present invention relates to the field of cutting devices, and more specifically to portable cutting devices for making precision guided cuts on objects of different sizes in metal, wood, or other materials.

### BACKGROUND OF THE INVENTION

Numerous cutting devices are currently being used to cut materials. For example, to cut metal or polymer pipes or to cut aluminium siding, a variety of manual and automatic portable cutting devices are often employed.

Tools having linear blades are used to cut an object by alternatively moving the blade back and forth on the object to be cut. In particular, portable cutting tools such as manual hacksaws, metal saws and other saws have been used to cut metallic or wooden objects. Such manual tools present numerous disadvantages, among which are loss of efficiency, exhausting the user and imprecision of cutting. Automatic tools having a linear blade have also been used in the prior art. These devices also present disadvantages and difficulties in that they are difficult to handle, unsuited for precision cuts, or lacking in efficiency.

Portable cutting devices that have a circular cutting tool or blade are also found in the prior art. For example, grinders having a circular grinding stone are used to grind objects, but are not suitable for cutting objects as they heat up the object when cutting, and present other difficulties and inefficiencies. Also known are cutting devices that use a circular blade that rotates to cut an object. Such circular blades are often mounted to apparatuses or include a guard that present difficulties and inefficiencies by rendering the apparatus difficult to handle, complex, among other things.

Some known cutting devices include various guards, guides and safeties to protect the user from cutting himself and others or to position and/or move the blade relative to the object to be cut. However, the guards or guides known in the art of portable cutting devices have numerous disadvantages including inefficiency, imprecision, non-versatility and complexity.

U.S. Pat. No. 5,974,674 (KELLY) describes an undercut saw for undercutting baseboards, doors and the like. This saw includes a blade guard subassembly covering much of the saw blade for safety purposes. The guard subassembly has a fixed component and a movable component. The movable component rotates about 180° with respect to the fixed component to enable undercutting. This saw has certain disadvantages, however, when it comes to cutting certain types of objects.

There is thus a need for a portable cutting device with a guiding guard that overcomes at least some of the disadvantages of the prior art.

### SUMMARY OF THE INVENTION

The present invention responds the above mentioned need by proposing a portable cutting device with guiding guard that overcomes various disadvantages of the prior art and presents other advantages for cutting certain objects of different sizes.

Accordingly, the present invention proposes a portable cutting device for cutting objects of different sizes. The device includes a frame and a circular blade drivably connected to the frame. The circular blade has a central portion, an intermediate portion and a periphery. The circular blade is also drivable along a rotation direction. The device also includes a guiding guard mounted to the frame and including first and second projections overlaying the intermediate portion of the circular blade and extending beyond the periphery thereof. Each projection has an edge being spaced-apart from and facing the respective edge of the other projection. The edges define therebetween a cutting area having a peripheral entrance to allow a cutting of one of said objects that is insertable within the cutting area as said one of said objects is guided toward the central portion along one of said edges that is facing the rotation direction, and to allow a partial cutting of another of said objects that is partially insertable within the cutting area as said another of said objects abuts against borders of the peripheral entrance. The device also includes a protector removably mounted around the peripheral entrance to removably cover the same.

Preferably, both of the edges are fixed and/or linear.

Also preferably, the guiding guard further includes at least one adjuster element, each being movably mounted to one of the first and second projections, and each having an adjustment edge defining one side of the cutting area. Each of the at least one adjuster element is movable to displace said adjustment edge to adjust the given dimensions of the cutting area.

Still preferably, a protector is slidably mounted to the guiding guard to removably cover the peripheral entrance. And still preferably, the device includes biasing means biasingly connecting the protector relative to the guiding guard to bias the protector to cover the peripheral entrance while allowing said protector to be displaced away there-from to expose the peripheral entrance.

The invention also proposes a portable cutting device for cutting an object, including a frame and a circular blade drivably connected to the frame and having a central portion, an intermediate portion and a periphery, the circular blade being drivable along a rotation direction, as described here-above. The device further includes a guiding guard mounted to the frame. The guiding guard includes first and second projections overlaying the intermediate portion of the circular blade and extending beyond the periphery thereof, the first projection facing the rotation direction. The projections are spaced-apart from and facing each other to define there-between a cutting area having a peripheral entrance and given dimensions, thereby allowing a cutting of the object within the cutting area as the object is guided toward the central portion along the first projection. The guiding guard also includes at least one adjuster element. Each adjuster element is movably mounted to one of the first and second projections, and has an edge defining one side of the cutting area. Each adjuster element is movable to displace said edge to adjust the given dimensions of the cutting area.

### BRIEF DESCRIPTION OF THE DRAWINGS

The invention is further illustrated and described in the detailed description and the drawings, in which:

FIG. 1 is a top perspective view of the cutting device according to a first embodiment of the present invention.

FIG. 2 is a top plan view of the cutting device of FIG. 1, wherein the protector is covering the blade.

FIG. 3 is a top plan view of the cutting device of FIG. 1, wherein the protector is exposing the blade.

FIG. 4 is a top perspective view of the cutting device of FIG. 1, manipulated by an operator for cutting a pipe.

FIG. 5 is a side view of the cutting device of FIG. 1.

FIG. 6 is a bottom plan view of the cutting device of FIG. 1, wherein the protector is covering the blade.

FIG. 7 is a bottom plan view of the cutting device of FIG. 1, wherein the protector is exposing the blade and cutting an insertable object.

FIG. 8 is a bottom plan view of the cutting device of FIG. 1, cutting a partially insertable object.

FIG. 9 is a top plan view of the cutting device according to a second embodiment of the present invention.

While the invention will be described in conjunction with example embodiments, it will be understood that it is not intended to limit the scope of the invention to such embodiments. On the contrary, it is intended to cover all alternatives, modifications and equivalents of the invention.

### DESCRIPTION OF PREFERRED EMBODIMENTS

In the following description, similar features in the drawings have been given same reference numerals and in order not to weigh down the Figs, some elements are not referred to in some Figs if they were already identified in a precedent Fig.

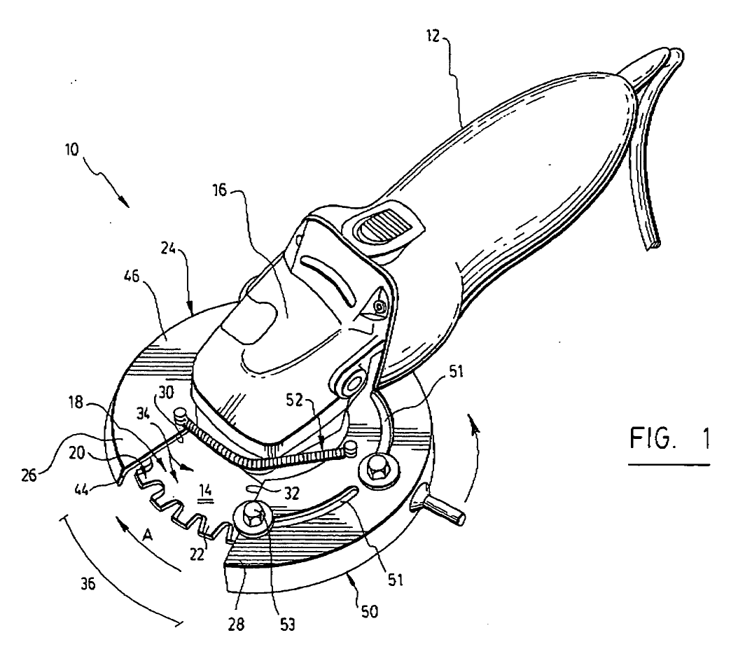

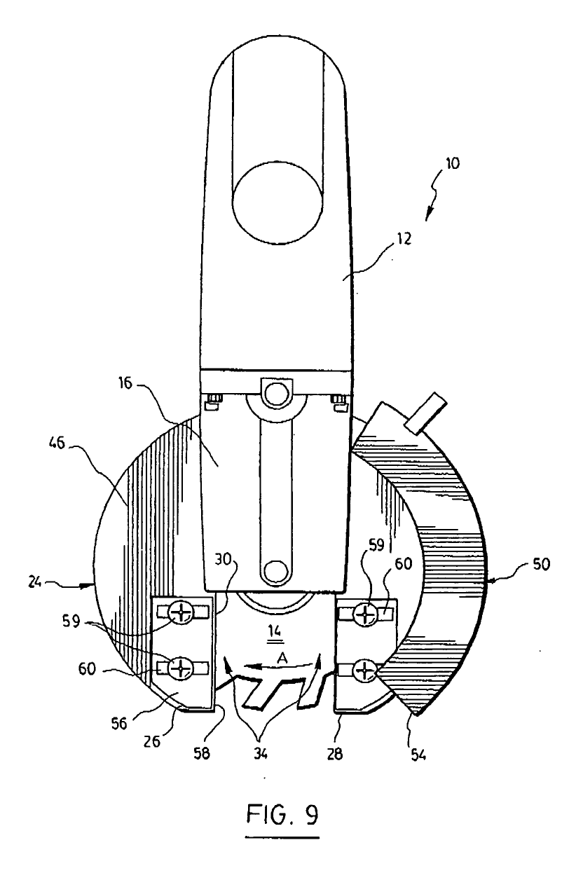

The first embodiment of the cutting device is illustrated in FIGS. 1 to 8, while the second embodiment is illustrated in FIG. 9. They share many common features, which will become apparent herebelow.

Referring to FIG. 1, the portable cutting device 10 has a main frame 12. To the frame 12, a circular blade 14 is drivably mounted. By drivably mounted it should be understood that the circular blade 14 is rotatably connected to the frame 12 so that a drive 16 may bring about the rotational movement of the blade. The speed of rotation is preferably about 2000 to 3000 RPMs, but could be modified depending on the operation of the drive and the properties of the object to be cut.

The circular blade 14 has a central portion (not shown) to which a rotary shaft is mountable to connect it to the drive 16. The blade 14 also has an intermediate portion 18 and a periphery 20. At the periphery 20 of the blade there are teeth 22 or other suitable cutting elements that may engage an object to cut the same. Preferably, the blade 14 is replaceable. The blade 14 is preferably constructed from carbide. However, it may also be made of steel, diamond tipped or not, or of any other material suitable for a particular cutting application. The blade 14 is also drivable along a rotation direction A.

Referring still to FIG. 1, the device 10 further includes a guiding guard 24 mounted to the frame 12. The guiding guard 24 includes first 26 and second 28 projections that overlay the intermediate portion 18 of the blade 14 and extend beyond the periphery 20. The projections 26, 28 may take on a variety of forms, including plate-shaped, rod-shaped or integrally formed with another part of the device 10. Each of the two projections 26, 28 has an edge 30, 32 that is spaced-apart from and facing the respective other edge 32, 30. By facing each other, the edges 30, 32 may cooperate to act as guides to the insertable objects. The edges 30, 32 define there-between a cutting area 34 having a peripheral entrance 36. This arrangement of the edges 30, 32 enables various objects to be cut as they pass the peripheral entrance 36 of the cutting area 34. Indeed, a myriad of different objects may be cut by the cutting device 10 of the present invention, some of which will be further discussed here-below.

Referring to FIG. 7, the cutting device 10 may cut an insertable object 38 as the latter is guided along the edge 30 facing the rotation direction A of the blade 14. In a particularly advantageous application of the device 10, elongated objects such as pipes are inserted laterally within the cutting area 34 and are severed. This is particularly advantageous in the plumbing, sanitation, chemical manufacturing and instrumentation industries, as well as in other industries in which cutting pipes is important. The device 10 enables an operator to simply hold a pipe 38 while bringing the cutting device 10 into operative contact therewith. More particularly, the operator brings the pipe 38 into contact with the periphery 20 of the blade 14, while the pipe 38 slides along the edge 30 facing the rotation direction A and while the other edge 32 cooperates with the first edge 30 to aid in the guiding. Preferably, the edges 30, 32 define a cutting area 34 that has dimensions that closely correspond to those of the object 38 to be cut. The insertable object 38 may therefore be tightly guided within the cutting area 34.

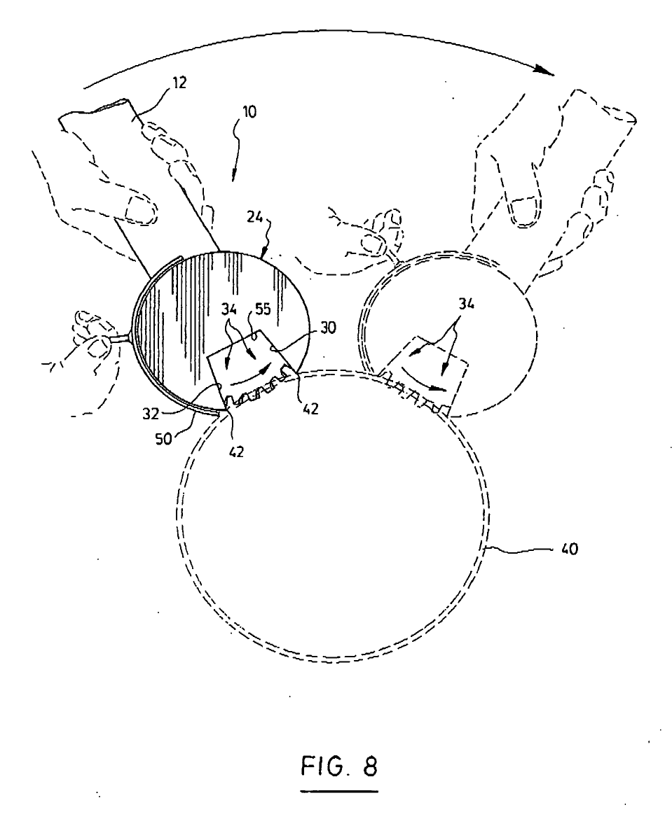

Now referring to FIG. 8, the cutting device may also cut a larger object 40, one that is only partially insertable within the cutting area 34. Indeed, this type of object may be a drum or a large pipe. In order to cut a large pipe 40, for instance, the peripheral entrance 36 is brought close to it and the borders 42 of the peripheral entrance 36 abut on the large pipe 40, thereby enabling the blade 14 to cut a kerf into the pipe 40. Subsequently, the device 10 may be slid around the circumference of the pipe 40, as illustrated in the Fig, thereby extending the kerf until it is brought full circle, as the case may be. There are a variety of methods of using the device 10 to cut larger objects, some of which are described herein.

Referring now to FIGS. 1, 7 and 8, it should be apparent, then, that the cutting device 10 is capable of cutting a variety of objects without being obliged to remove the guard, blade or other parts of the device. The projections 26, 28 are arranged to provide edges 30, 32 and abutment surfaces such as the borders 42 of the peripheral entrance 36 to facilitate these different cutting jobs. By providing the projections with edges 30, 32 that are facing each other and are spaced-apart, one allows the insertion of elongated objects there-between while providing highly desirable guiding ability; and by arranging the edges relative to each other and the blade, one further allows other advantageous types of cutting.

One advantage of the device 10 is that the insertable objects 38 may be guided from beyond the periphery into the cutting area 34. As the insertable object 38 engages the blade 14, it is substantially forced toward the edge 30 facing the rotation direction A. Nevertheless, during cutting the object 38 may experience vibration, random movements and/or kickbacks from the rapid blade rotation. The second edge 32 thus provides added guiding ability and security.

Preferably, the edges 30, 32 are fixed with respect to the projections 26, 28 to improve the guiding of insertable objects 38. The edges 30, 32 are preferably linear and may be angled with respect to one another to define a cutting area 34 that is wider near the peripheral entrance 36, but the edges 30, 32 may also be parallel. Also preferably, at least one of the projections 26, 28 further includes a flange member 44 extending normal with respect to the rotation direction A. The edges 30, 32 also preferably intersect the circular blade 14 at an angle that encourages the insertable object 38 to be displaced toward the edge 30, to facilitate the initial cutting of the insertable object 38.

In FIGS. 1, 6 and 7, the guiding guard 24 further includes an upper plate 46 and a lower plate 48 enclosing the circular blade 14 there-in-between with the exception of the cutting area 34. The upper and lower plates 46, 48 allow greater safety and stability during operation of the device 10. Preferably, the projections 26, 28 are integrally formed with the upper plate 46 and are coplanar therewith. In particular for metal cutting applications, the reinforced projections 26, 28 define solid, fixed edges 30, 32 for smooth and reliable guiding. Also, coplanar edges 30, 32 may improve the guiding, as an insertable object may be supported in a balanced manner. The projections 26, 28 and the upper plate 46 are preferably made of one piece, but they may also be separate, detachable pieces, lockably removable or fixed to each other. The projections 26, 28 may also be mounted to the main frame 12 instead of to the upper plate 46.

The flange member 44 preferably extends down from the outer rim of the upper plate 46 in front of and across the periphery 20 of the blade 14. The flange member 44 may also extend upward away from the blade 14, or further downward, to thereby provide the edges 30, 32 with a greater surface to aid in guiding an insertable object 38. Furthermore, when the flange member 44 extends away from the blade 14, it may be arranged along the length of the edge 30—that is, from proximate periphery to proximate the central portion—, to aid in guiding the object within the cutting area 34. By projecting normal to the rotation direction A and extending along the length of the edge 30, the flange member 44 may help to orient a pipe 38, for instance, to cut the pipe 38 radially at a right-angle.

The cutting device 10 also includes a protector 50 removably mounted around the peripheral entrance 36 to removalby cover the same. The protector 50 may be any type known in the art and is notably present to conform to safety standards of the industry. As an exposed blade may give rise to numerous dangers in the workplace, the protector 50 is primarily used to protect the operator. However, as will be described below, the protector 50 may present other features and advantages.

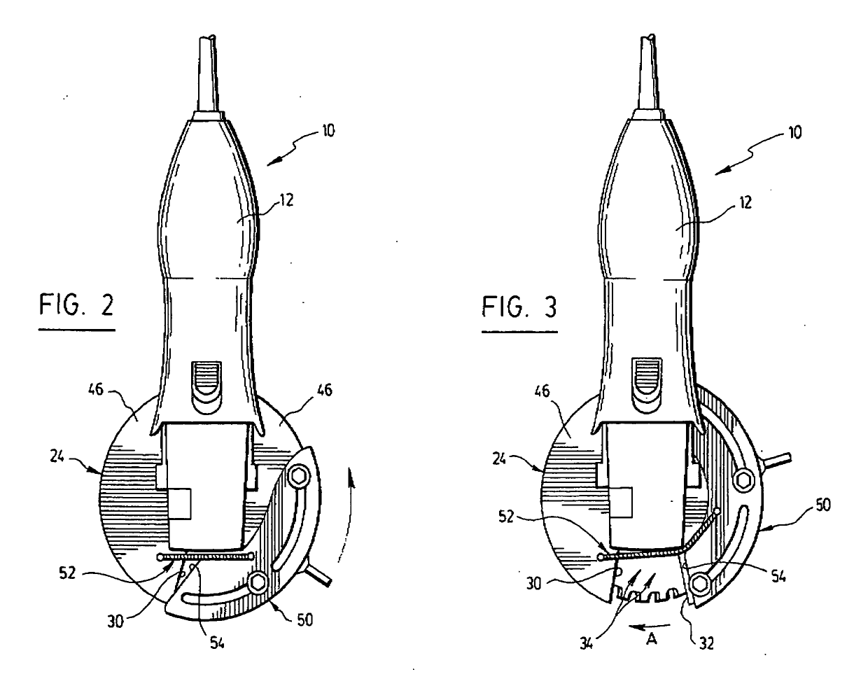

As shown in FIG. 1, the protector 50 is preferably slidably mounted to the side of the guiding guard 24. This enables the protector 50 to be easily slid away to expose the peripheral entrance 36 to the cutting area 34. It should also be noted that the protector 50 may be mounted to the guiding guard 24 in another way, be it clipped, clamped or screwed, to cover the peripheral entrance 36 while being removable. The embodiment of the device 10 of FIG. 1 illustrates a preferred arrangement, wherein the protector 50 has elongated slots 51 through which bolts 53 are inserted and slidable therein, to allow the protector 50 to be displaced around the guiding guard 24 from a closed position (as shown in FIG. 2) to an open position (as shown in FIG. 3).

Preferably, the protector 50 further includes biasing means 52 for biasing the protector 50 toward the closed position while allowing the protector 50 to be displaced to the open position. The biasing means 52 may be selected from a variety of mechanisms that can store potential energy, and preferably are a spring-based mechanism. In such a case, a variety of springs may be used. In the embodiment shown in FIGS. 2 and 3, a coil-type spring 52 is fixed at one of its ends to the protector 50 and at its other end to the opposite projection 30, thus spanning the cutting area 34 at a back end thereof.

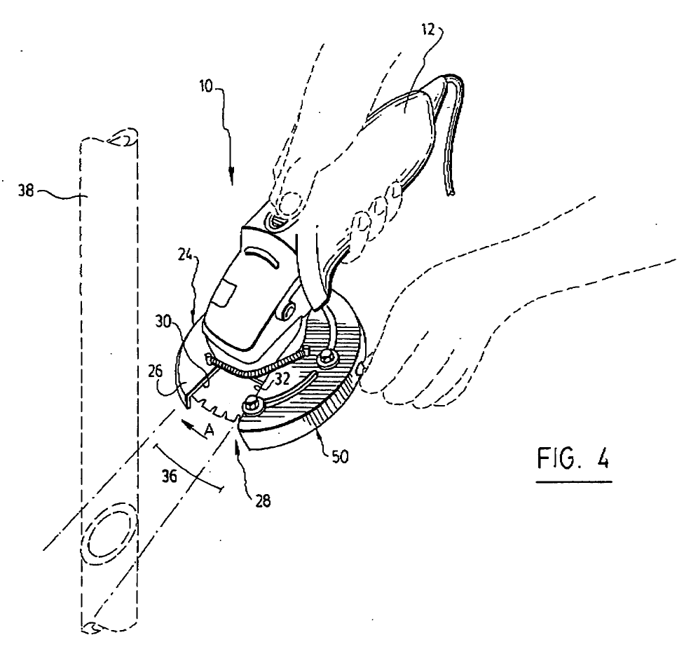

One advantage of the biasing means 52 is that the protector 50 may aid in the guiding of the insertable object 38. For instance, the object 38 is first brought to push the protector 50 from the closed position toward the open position, thereby exposing the cutting area 34. The object 38 is then slid past the peripheral entrance 36 and along the edge 30 while the inner edge 54 of the protector 50 biasingly abuts the opposite side of the object 38. Thus, the cutting area 34 automatically adapts to the shape of the object. Alternatively, and as shown in FIGS. 4, 7 and 8, the operator may fully open the protector 50 while cutting.

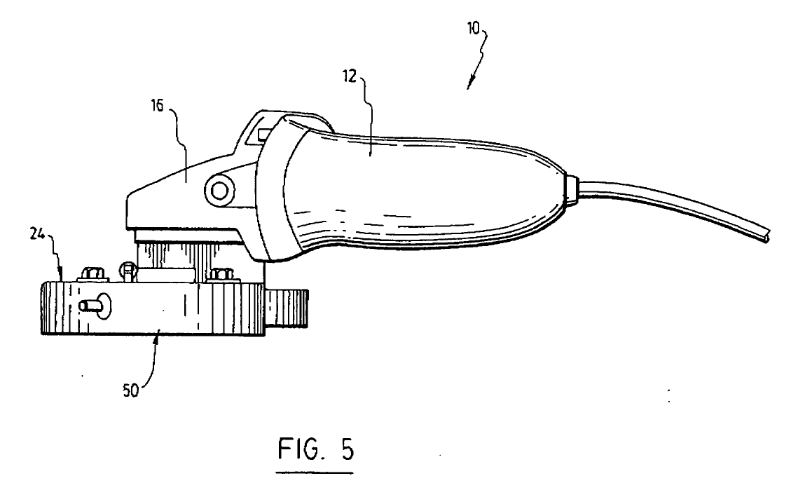

Preferably, the frame 12 of the device 10 extends away and opposite from the cutting area 34. This arrangement has been found to provide certain advantages during cutting. For instance, an operator is able to perform a cutting away from his body, which enables increased safety. Also, the operator is able to use the device 10 with a simple extension of his arm, which is a technique that is easy and effective. Also, as illustrated in FIG. 5, the blade and guiding guard 24 are preferably located beneath the frame 12 of the cutting device 10.

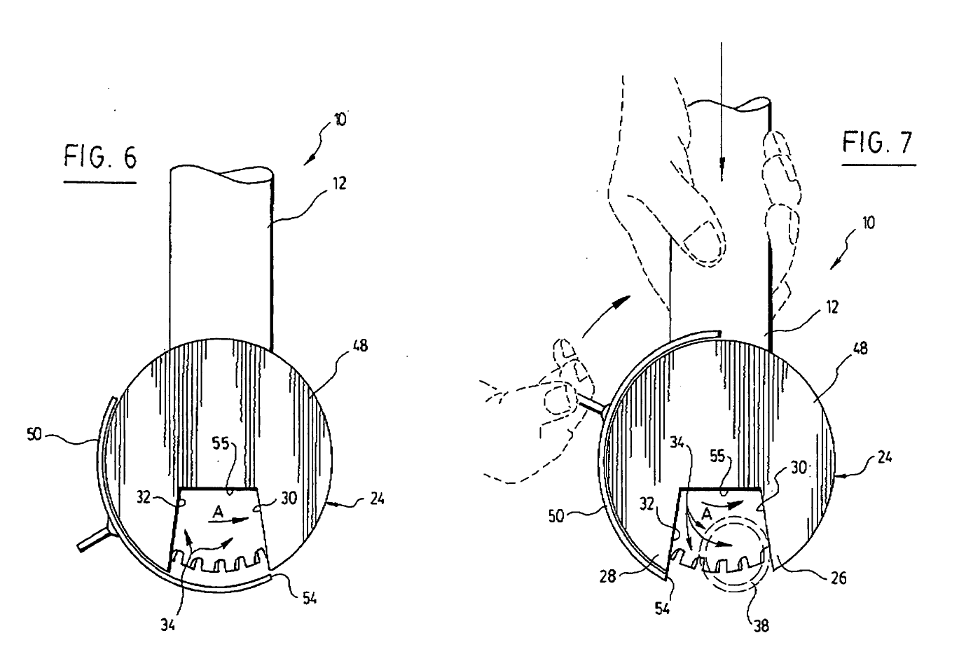

Referring to FIGS. 6 and 7, the guiding guard 24 preferably includes a stopper edge 55 proximate to the central portion of the blade 14. The stopper edge 55 delimits the back side of the cutting area 34. This provides certain advantages when cutting notches or natching, or in other circumstances when a cut is to be limited to a certain depth.

Now referring to FIG. 9, the cutting device 10 preferably includes at least one adjuster element 56. Preferably, as shown in the Fig, there are two adjuster elements 56 mounted on opposite projections. In order to adjust the given dimensions of the cutting area 34, the adjuster elements 56 are movably mounted to the first and second projections 26, 28. Each of the adjuster elements 56 has an adjustment edge 58 defining one side of the cutting area 34. Each of the adjuster elements 56 is movable to displace the adjustment edge 58 to adjust the given dimensions of the cutting area 34.

The adjuster elements 56 preferably take the form of plate members, but they may alternatively be other elements that are able to define an edge 58 that is adjustable. Also, the adjustment elements 56 are displaceable to adjust the dimensions of the cutting area 34 by modifying its width, depth or the edge angles. Thus, the adjuster elements 56 may be slidably, pivotably or rotatably mounted to the device 10. Thus, the adjuster elements 56 may be translated, pivoted or rotated and then fixed in their new position, to modify the dimensions of the cutting area 34 and enable new cutting abilities.

In FIG. 9, the plate member 56 has a side defining the adjustment edge 58. The plate member 56 is provided with elongated eyelets 60 having a given span. Fasteners 59 are insertable through the eyelets 60 and securable at different locations along the given span thereof to removably secure the plate member 56 against the projection 26, 28 in different positions. In the illustrated embodiment, the eyelets 60 are oriented to primarily enable lateral translation of the plate members 56 to adjust the width of the cutting area 34. Alternatively, the eyelets 60 may be oriented to enable the plate members 56 to be translated further beyond the periphery of the blade 14, thereby adjusting the length of the cutting area 34. Also, the plate members 56 may be rotated to allow the angles of the edges 30, 32 to be adjusted.

The guiding guard 24 thus allows some advantageous functions. For instance, it may protect the user and others from the blade, position objects relative to the cutting area before cutting, and guide and/or position the object during cutting.

The device 10 is particularly suitable for cutting 2 inch diameter pipes that are insertable within the cutting area 34, but may also easily cut smaller or larger pipes. Furthermore, the device 10 is particularly suited for cutting steel of ⅛^{th} inch, but may also be used to cut other materials of other thicknesses. Also, the device 10 is advantageous when natching or cutting the nose of aluminium siding. In the case of aluminium siding, cutting the nose of individual pieces is often an important operation to be able to put sealant, wrapping or other materials into the cut notch. The present invention is particularly advantageous for making small and/or precision cuts in metal in many applications. The portable device is easily handled, using the stability of the circular blade movement with the guiding effect of the first and second projections which define the cutting area, while protecting the user from the blade in key areas.

The portable cutting device 10 according to the present invention was used to cut a plurality of pipes, barrels, rods, planks and bars made of materials chosen from plastic, metal including steel and wood. Using the embodiment shown in FIG. 1, for example, the operator was able to quickly go from one object to another, cutting the different objects as desired. The objects were laid on a surface such as a table, and were optionally allowed to overhang one end to allow cutting. The cutting device 10 performed a variety of cutting procedures on a variety of materials and objects. FIG. 4 shows an operator performing an oblique cut on a pipe 38, but straight transverse cuts, i.e. right angled cuts, are easily performed.

For example, threaded metal rods of ¼′ inch, ½ inch and 1 inch diameters, were cut and then immediately threaded into corresponding bolts, thereby showing that the cut was clean. The rods did not, therefore, need to be sanded down to allow a bolt to be twisted on. Also, a ¼ inch metal bolt was cut. The device is thus quite versatile and enables rapid, efficient cutting of threaded rods and corresponding fixings.

In another example, plastic PVC tubes 4 inch, 2 inch and 1 ¾ inch diameters were cut. Here, as the pipes were only partially insertable within the cutting area of the device, the pipes were laid flat on a table surface, the divec was brought to engage the pipe so that the borders of the peripheral entrance of the cutting area abutted on the pipe, and the pipe was then rotate on the table while the device was held relatively still. This enabled the entire circumpherence of each pipe to be cut by the device.

In further examples, copper pipes of 1 inch, 1 ⅛ inch, 1 ½ inch and 2 ¼ inch diameters were cut; an aluminium rod of 1 inch diameter was cut; a metal pipe of 1 ⅛ inch, 2 inch and 3 ½ inch diameters were cut; a thick metal pipe of 1 ¼×⅛ (inches) was cut; an aluminium tube of 1×1 and 1 ¾×1 ¾ (inches) and an aluminium angles of 1×1 and 2×2 (inches) were cut; metal of ⅛ inch, and electric wire of 1 ¾ and 1 1/4 inches.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

What is claimed is:

1. A portable cutting device for cutting objects of different sizes, comprising:
a frame;
a circular blade drivably connected to the frame and having a central portion, an intermediate portion and a periphery, the circular blade being drivable along a rotation direction;
a guiding guard mounted to the frame and comprising first and second projections overlaying the intermediate portion of the circular blade and extending beyond the periphery thereof, each projection having an edge being spaced-apart from and facing the respective edge of the other projection, said edges defining therebetween a cutting area having a peripheral entrance to allow a cutting of one of said objects that is insertable within the cutting area as said one of said objects is guided toward the central portion along one of said edges that is facing the rotation direction, and to allow a partial cutting of another of said objects that is partially insertable within the cutting area as said another of said objects abuts against borders of the peripheral entrance; and
a protector removably mounted around the peripheral entrance to removably cover the same.

2. The portable cutting device of claim 1, wherein the edges are fixed.

3. The portable cutting device of claim 1, wherein the edges are angled relative to each other so that the cutting area has a width that is greater proximate to the periphery of the circular blade than to the central portion.

4. The portable cutting device of claim 1, wherein the edges are linear.

5. The portable cutting device of claim 1, wherein the projection having the edge facing the rotation direction further comprises a flange member extending from said edge normally with respect to the rotation direction.

6. The portable cutting device of claim 1, wherein the guiding guard further comprises an upper plate and a lower plate enclosing the circular blade thereinbetween with the exception of the cutting area.

7. The portable cutting device of claim 6, wherein the projections are intergral with the upper plate and are coplanar therewith.

8. The portable cutting device of claim 1, further comprising a stopper edge for delimiting the cutting area proximate to the central portion of the circular blade.

9. The portable cutting device of claim 1, wherein the frame comprises a body portion holdable by an operator and extending away from and opposite to the cutting area.

10. The portable cutting device of claim 1, wherein the edges provide the cutting area with given dimensions and the guiding guard further comprises at least one adjuster element, each being movably mounted to one of the first and second projections, and each having an adjustment edge defining one side of the cutting area, each of the at least one adjuster element being movable to displace said adjustment edge to adjust the given dimensions of the cutting area.

11. The portable cutting device of claim 1, wherein the protector is slidably mounted to the guiding guard to removably cover the peripheral entrance.

12. The portable cutting device of claim 11, further comprising biasing means biasingly connecting the protector relative to the guiding guard to bias the protector to cover the peripheral entrance while allowing said protector to be diplaced away therefrom to expose the peripheral entrance.

13. A portable cutting device for cutting an object, comprising:
a frame;
a circular blade drivably connected to the frame and having a central portion, an intermediate portion and a periphery, the circular blade being drivable along a rotation direction;
a guiding guard mounted to the frame and comprising:
first and second projections overlaying the intermediate portion of the circular blade and extending beyond the periphery thereof, the first projection facing the rotation direction, said projections being spaced-apart from and facing each other to define therebetween a cutting area having a peripheral entrance and given dimensions, thereby allowing a cutting of the object within the cutting area as the object is guided toward the central portion along the first projection; and
at least one adjuster element each movably mounted to one of the first and second projections, each of the at least one adjuster element having an edge defining one side of the cutting area and being movable to displace said edge to adjust the given dimensions of the cutting area.

14. The portable cutting device of claim 13, wherein the at least one adjuster element comprises first and second adjuster elements respectively mounted to the first and second projections.

15. The portable cutting device of claim 14, wherein the first and second adjuster elements are adjustable to allow a cutting of one of said objects that is insertable within the cutting area as said one of said objects is guided toward the central portion along one of said edges that is facing the rotation direction, and allow a partial cutting of another of said objects that is partially insertable within the cutting area as said another of said objects abuts against borders of the peripheral entrance.

16. The portable cutting device of claim 13, further comprising a protector slidably mounted to the guiding guard to removably cover the peripheral entrance.

17. The portable cutting device of claim 16, further comprising biasing means biasingly connecting the potector relative to the guiding guard to bias the protector to cover the peripheral entrance while allowing said protector to be diplaced away therefrom.

18. The portable cutting device of claim 13, wherein each adjuster element comprises:
a plate member having a side defining the edge, the plate member being provided with at least one elongated eyelet having a given span;
at least one fastener insertable through the at least one eyelet and securable at different locations along the given span thereof so as to removably secure the plate member against the projection in different positions.
